(19) United States
(12) Patent Application Publication
(10) Pub. No.: US 2002/0083801 A1
(43) Pub. Date: Jul. 4, 2002

(54) Universal socket structure

(76) Inventor: Chin-Shun Cheng, Tai-Ping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/749,516

(22) Filed: Dec. 28, 2000

(51) Int. Cl. B25B 23/16

(52) U.S. Cl. 81/177.75

(57) ABSTRACT

A universal socket structure includes a socket body, a mobile body having a first end pivotally mounted on a first end of the socket body so that the mobile body can be rotated relative to the socket body through a determined angle, and a sleeve slidably mounted on the socket body. In such a manner, the sleeve is slidable between a first position where the sleeve has a first end rested on the first end of the socket body and a second end rested on the first end of the mobile body so that the first end of the mobile body is fixed to the first end of the socket body, and a second position where the second end of the sleeve is detached from the first end of the mobile body so that the mobile body can be rotated relative to the socket body.

### BACKGROUND OF THE INVENTION

1. Field of the Invention

The present invention relates to a universal socket structure.

2. Description of the Related Art

A conventional universal socket 5 in accordance with the prior art shown in FIGS. 7 and 8 comprises a socket body 50, and a mobile body 51 having a first end pivotally mounted on a first end of the socket body 50 so that the mobile body 51 can be pivoted relative to the socket body 50 through a determined angle. The socket body 50 has a second end formed with a joint portion for engaging with a socket wrench (not shown), and the mobile body 51 has a second end defining a recess 511 for operating a workpiece (not shown) such as a nut, a bolt or the like.

The first end of the socket body 50 is provided with a spherical body 501 defining a slot 502, and the first end of the mobile body 51 defines a through hole 512 aligning with the slot 502 of the spherical body 501 of the socket body 50. A pivot axle 52 in turn extends through the through hole 512 of the mobile body 51 and through the slot 502 of the spherical body 501 of the socket body 50 so that the mobile body 51 is pivoted to the spherical body 501 of the socket body 50.

However, when the conventional universal socket 5 co-operates with the socket wrench to operate the workpiece, the mobile body 51 is easily pivoted relative to the socket body 50 so that the conventional universal socket 5 cannot be adapted to function as a normal in-line socket, thereby limiting the versatility thereof

### SUMMARY OF THE INVENTION

In accordance with one aspect of the present invention, there is provided a universal socket structure comprising:

a socket body;

a mobile body having a first end pivotally mounted on a first end of the socket body so that the mobile body can be rotated relative to the socket body through a determined angle; and

a sleeve slidably mounted on the socket body so that the sleeve is slidable between a first position where the sleeve has a first end rested on the first end of the socket body and a second end rested on the first end of the mobile body so that the first end of the mobile body is fixed to the first end of the socket body, and a second position where the second end of the sleeve is detached from the first end of the mobile body so that the mobile body can be rotated relative to the socket body.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a universal socket structure in accordance with a first embodiment of the present invention;

FIG. 2 is a partially exploded view of the universal socket structure as shown in FIG. 1;

FIG. 3 is a partially exploded view of the universal socket structure as shown in FIG. 1;

FIG. 4 is a front plan cross-sectional view of the universal socket structure as shown in FIG. 1;

FIG. 5 is a perspective view of a universal socket structure in accordance with a second embodiment of the present invention;

FIG. 6 is a front plan cross-sectional view of the universal socket structure as shown in FIG. 5;

FIG. 7 is an exploded view of a conventional universal socket in accordance with the prior art; and

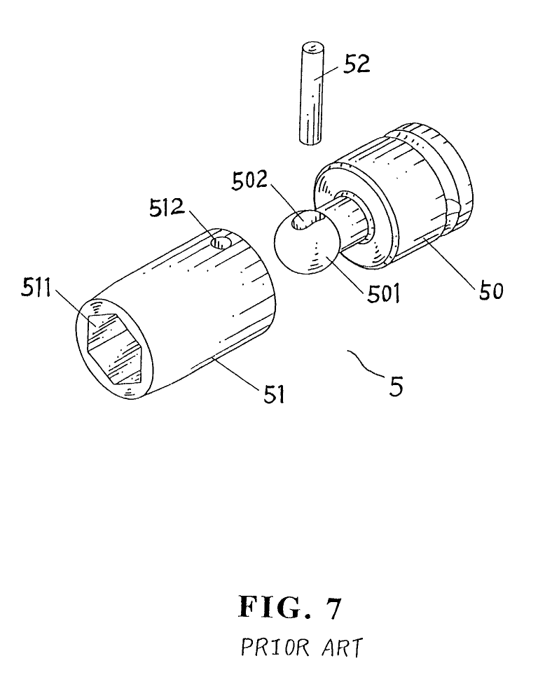

FIG. 8 is a perspective assembly view of the conventional universal socket as shown in FIG. 7.

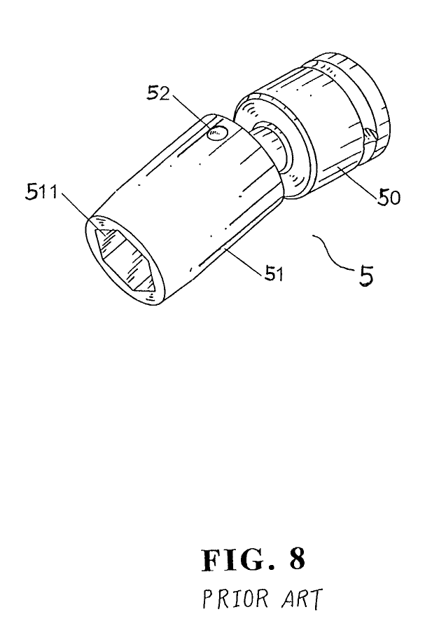

### DETAILED DESCRIPTION OF THE INVENTION

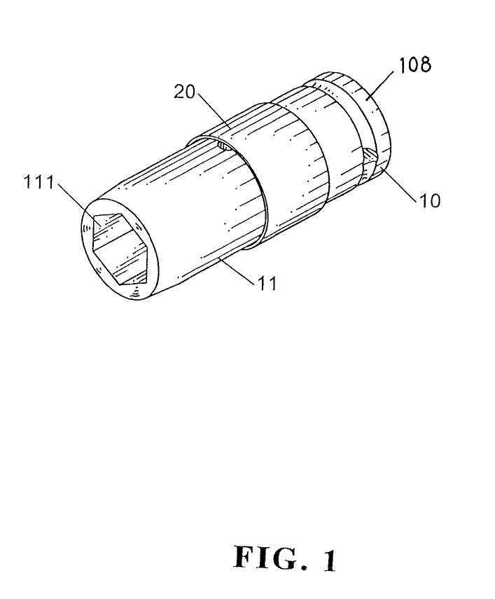

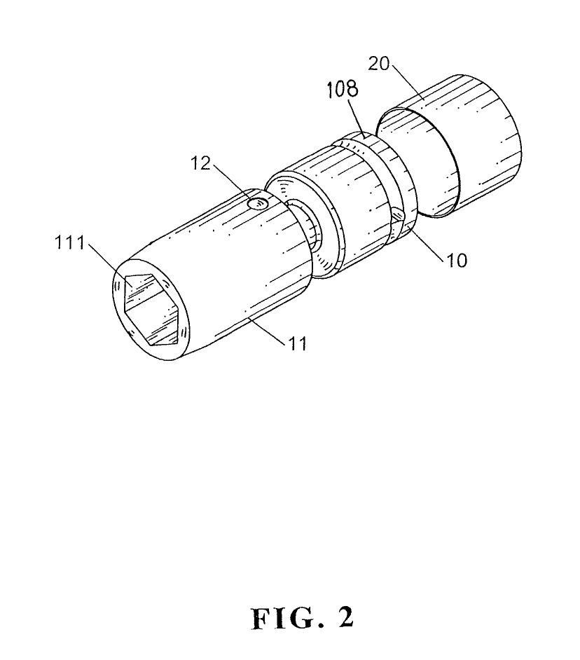

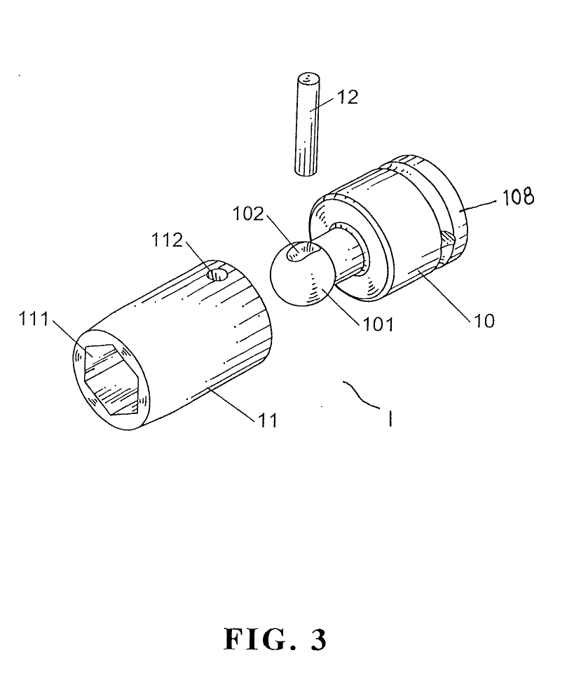

Referring to the drawings and initially to FIGS. 1-4, a universal socket structure 1 in accordance with a first embodiment of the present invention comprises a socket body 10, a mobile body 11 having a first end pivotally mounted on a first end of the socket body 10 so that the mobile body 11 can be rotated relative to the socket body 10 through a determined angle, and a sleeve 20 slidably mounted on the socket body 10.

The socket body 10 has a second end formed with a joint portion 108 for engaging with a socket wrench (not shown), and the mobile body 11 has a second end defining a recess 111 for operating a workpiece (not shown) such as a nut, a bolt or the like.

The first end of the socket body 10 is provided with a spherical body 101 defining an elongated arcuate slot 102, the first end of the mobile body 11 defines a through hole 112 aligning with the arcuate slot 102 of the spherical body 101 of the socket body 10, and the universal socket structure further comprises a pivot axle 12 extending through the through hole 112 of the mobile body 11 and through the arcuate slot 102 of the spherical body 101 of the socket body 10 so that the mobile body 11 is pivotably mounted on the spherical body 101 of the socket body 10.

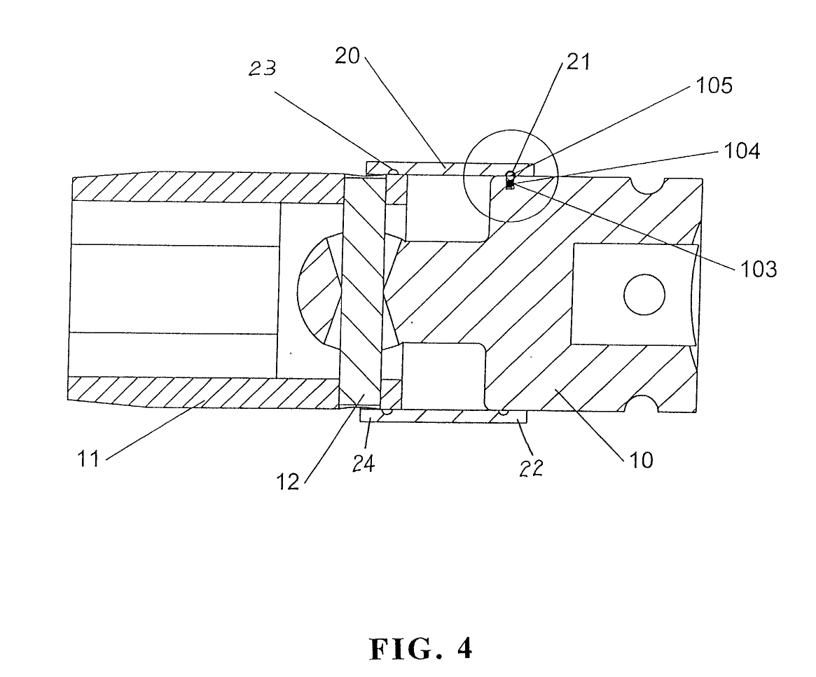

In operation, the sleeve 20 is slidable and movable on the socket body 10 between a first position as shown in FIG. 4 where the sleeve 20 has a first end 22 rested on the outer wall of the first end of the socket body 10 and a second end 24 rested on the outer wall of the first end of the mobile body 11 so that the first end of the mobile body 11 is fixed to the first end of the socket body 10 and cannot be rotated relative to the socket body 10 so that the universal socket structure 1 of the present invention can be adapted to function as a normal in-line socket, and a second position where the second end 24 of the sleeve 20 is detached from the outer wall of the first end of the mobile body 11 so that the mobile body 11 can be pivoted relative to the socket body 10 and so that the universal socket structure 1 of the present invention can be adapted to function as a universal socket.

The sleeve 20 has an inner wall defining a first annular groove 21 located adjacent to the first end 22 thereof and a second annular groove 21 located adjacent to the second end 24 thereof The socket body 10 has an outer wall defining a receiving hole 103 located adjacent to the first end thereof. The universal socket structure further comprises an urging block 105 movably mounted in the receiving hole 103 of the socket body 10 and detachably locked in one of the first annular groove 21 and the second annular groove 23 of the sleeve 20, and an elastic body 104 mounted in the receiving hole 103 of the socket body 10 and urged on the urging block 105.

In such a manner, when the sleeve 20 is moved to the first position as shown in FIG. 4, the urging block 105 is inserted and locked into the first annular groove 21 of the sleeve 20 for retaining the sleeve 20, and when the sleeve 20 is moved to the second position, the urging block 105 is inserted and locked into the second annular groove 23 of the sleeve 20 for retaining the sleeve 20.

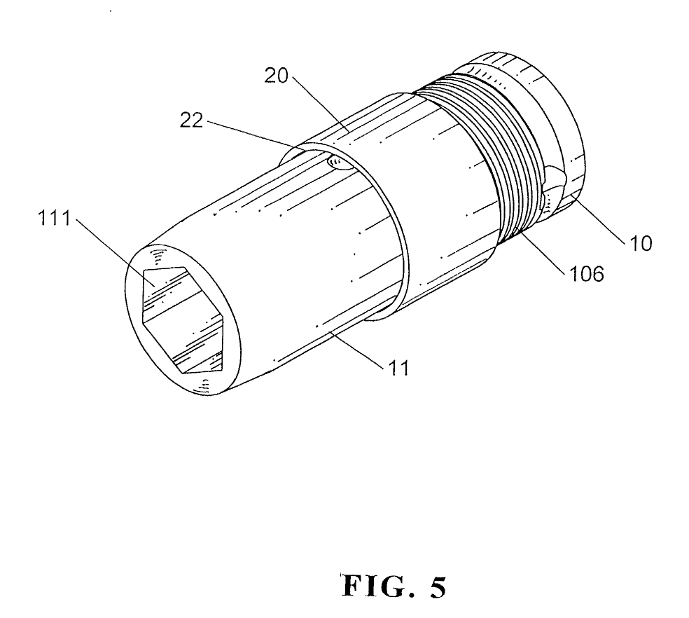

Referring to FIG. 5, in accordance with a second embodiment of the present invention, the socket body 10 has an outer wall provided with an outer thread 106, and the sleeve 20 has an inner wall provided with an inner thread 22 screwed on the outer thread 106 of the socket body 10 so that the sleeve 20 is rotatably and slidably mounted on the socket body 10.

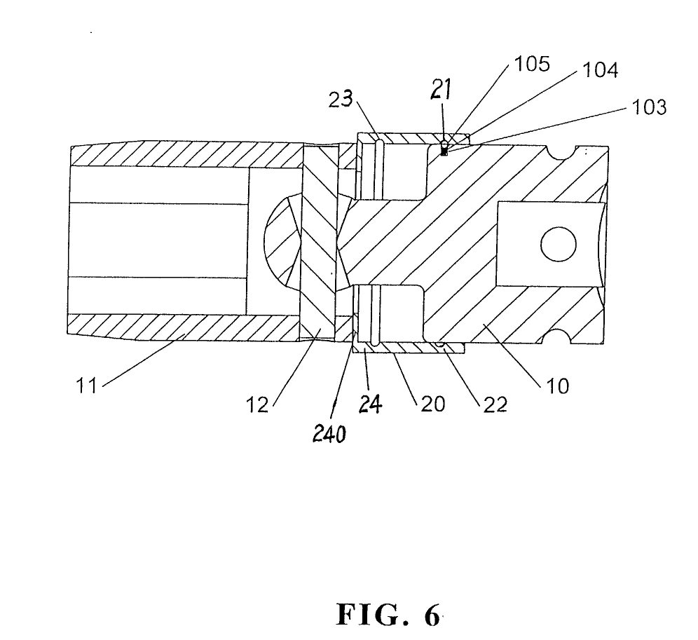

Referring to FIG. 6, in accordance with a third embodiment of the present invention, the second end 24 of the sleeve 20 is provided with an abutting surface 240 detachably rested on the first end of the mobile body 11.

Accordingly, by means of moving and adjusting the sleeve 20, the universal socket structure 1 of the present invention can be adapted to function as a normal in-line socket or a universal socket, thereby greatly enhancing the versatility of the universal socket structure.

It should be clear to those skilled in the art that further embodiments may be made without departing from the scope of the present invention.

What is claimed is:

1. A universal socket structure comprising:
a socket body (10);
a mobile body (11) having a first end pivotally mounted on a first end of said socket body (10) so that said mobile body (11) can be rotated relative to said socket body (10) through a determined angle; and
a sleeve (20) slidably mounted on said socket body (10) so that said sleeve (20) is slidable between a first position where said sleeve (20) has a first end (22) rested on said first end of said socket body (10) and a second end (24) rested on said first end of said mobile body (11) so that said first end of said mobile body (11) is fixed to said first end of said socket body (10), and a second position where said second end of said sleeve (20) is detached from said first end of said mobile body (11) so that said mobile body (11) can be rotated relative to said socket body (10).

2. The universal socket structure in accordance with claim 1, wherein said sleeve (20) has an inner wall defining a first annular groove (21) located adjacent to the first end (22) thereof and a second annular groove (21) located adjacent to the second end (24) thereof, said socket body (10) has an outer wall defining a receiving hole (103) located adjacent to the first end thereof, and said universal socket structure further comprises an urging block (105) movably mounted in said receiving hole (103) of said socket body (10) and detachably locked in one of said first annular groove (21) and said second annular groove (23) of said sleeve (20), and an elastic body (104) mounted in said receiving hole (103) of said socket body (10) and urged on said urging block (105).

3. The universal socket structure in accordance with claim 1, wherein said socket body (10) has an outer wall provided with an outer thread (106), and said sleeve (20) has an inner wall provided with an inner thread (22) screwed on said outer thread (106) of said socket body (10) so that said sleeve (20) is rotatably and slidably mounted on said socket body (10).

4. The universal socket structure in accordance with claim 1, wherein said second end (24) of said sleeve (20) is provided with an abutting surface (240) detachably rested on said first end of said mobile body (11).

5. The universal socket structure in accordance with claim 1, wherein said first end of said socket body (10) is provided with a spherical body (101) defining an elongated arcuate slot (102), said first end of said mobile body (11) defines a through hole (112) aligning with said arcuate slot (102) of said spherical body (101) of said socket body (10), and said universal socket structure further comprises a pivot axle (12) extending through said through hole (112) of said mobile body (11) and through said arcuate slot (102) of said spherical body (101) of said socket body (10) so that said mobile body (11) is pivotably mounted on said spherical body (101) of said socket body (10).
